(19) United States
(12) Patent Application Publication
(10) Pub. No.: US 2022/0051261 A1
(43) Pub. Date: Feb. 17, 2022

(54) PROCESSES AND SYSTEMS OF BLOCKCHAIN WITH VERIFICATION THROUGH A CONSORTIUM OF STAKEHOLDERS

(71) Applicant: Samuel Vetas, Salt Lake City, UT (US)

(72) Inventor: Samuel Vetas, Salt Lake City, UT (US)

(21) Appl. No.: 17/334,721

(22) Filed: May 29, 2021

Related U.S. Application Data
(60) Provisional application No. 63/032,466, filed on May 29, 2020.

(51) Int. Cl. G06Q 30/00; G06Q 10/08

(52) U.S. Cl. CPC G06Q 30/018; G06Q 2220/00; G06Q 10/0833

(57) ABSTRACT

In a management system having a blockchain structure, the system includes a consortium of stakeholder computers connected to a platform. The consortium of stakeholders providing user inputted data associated with product providence. The platform is integrated with a blockchain database to verify and manage user inputted data. The platform is configured to validate and assign values to the user inputted data to connect to related data within the blockchain database. A user interface is configured to display qualified data based on user search queries and focus search results to provide a roadmap of the data relevant to a particular product or value.

### CROSS-REFERENCE TO RELATED APPLICATIONS

This application claims the benefit of U.S. Provisional Patent Application Serial No. 63/032,466, entitled “Processes and Systems of Blockchain with Verification Through a Consortium of Stakeholders”, filed May 29, 2020, which is incorporated herein by reference.

### BACKGROUND OF THE INVENTION

### 1. The Field of the Invention

The present disclosure generally relates to systems using blockchain technology and, more particularly, to systems for securing data through blockchains being transmitted between a consortium of stakeholders.

### 2. The Relevant Technology

Blockchain technology has gained traction throughout many areas of businesses and industries, including the supply chain industry. A blockchain is a type of database that has collection of information stored electronically in a computer system. The information may be stored in a structured table format to allow for easier searching and filtering of the information.

Large databases store data on servers that consist of many powerful computers. The servers have computational power and storage capacity to allow many users the capability to access the database at the same time.

A blockchain differs from a typical database in the way that the data is structured. The information is collected in groups, called blocks. The blocks have specific storage capacities. When a block is filled with data, the information can be linked to other blocks, creating a chain of filled blocks of data called blockchains. New information that follows a block is compiled into a new block and is connected to a particular chain.

A typical database structures information in tables. A blockchain, on the other hand, structures the data in blocks that are chained together. Data written in a blockchain cannot be changed. The blockchains are an irreversible timeline of data. The information cannot be changed or deleted. When a block is filled with information, the data is set in stone and becomes a part of the blockchain timeline. Each block in the chain is given a timestamp when the block is added to a chain.

Supply chain professionals are becoming aware of the technology and are starting to find uses for blockchain to track and trace products. The rigidity of blockchain technology can offer great benefits throughout the supply chain industry. Once information is collected, the data cannot be manipulated or deleted to provide a true and untampered chain of information.

The world's supply chains experienced significant disruptions. This can become a global problem. Empty shelves due to a panic buying can distort true demand information and made supply stocks inadequate to provide essential staples to consumers around the world. The most reported example of this was the significant shortage of toilet paper on empty store shelves throughout the world.

The problem for these disruptions in supply chains is that companies historically have not invested to develop the proper technology to provide visibility beyond one or two levels upstream or downstream for participants within the supply chain. Companies simply cannot see what disruptions may be coming. An efficient supply chain management process requires reliable suppliers and the ability to assess variation in supply and demand throughout the chain. Furthermore, the large segregation of suppliers and intermediaries made it even harder to differentiate illegitimate participants from legitimate ones, adding unnecessary friction to commerce.

Disruptions can be avoided if companies had a tamper-proof, coherent, and resilient technology system. Consider, for example, the significant supply shocks to personal protective equipment for healthcare workers and the general population in addition to the current issues with the distribution of vaccines being delivered to patients rapidly and efficiently. This process has been very slow and clunky due to the lack of track and trace technology, logistics, planning, and visibility throughout the supply chain.

Currently, the hemp supply chain is in a state of disarray. It is characterized by opacity, fragmentation, lack of reliable payment systems, the inability to verify “real” buyers and sellers, and the inability to verify product provenance and quality according to federal and state regulatory requirements. Its highly decentralized farming community also suffers from an inefficient method of sourcing the labor necessary for sustained continuity of operations. Owing to its relative immaturity, the industrial hemp industry is underserved by a supply-chain solution targeting its needs.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

In one aspect of the invention, a management system has a blockchain structure, the system includes a consortium of stakeholder computers connected to a platform. The consortium of stakeholders providing user inputted data associated with product providence. The platform is integrated with a blockchain database to verify and manage user inputted data. The platform is configured to validate and assign values to the user inputted data to connect to related data within the blockchain database. A user interface is configured to display qualified data based on user search queries and focus search results to provide a roadmap of the data relevant to a particular product or value.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 is a block diagram of an overview of the data, traceability and compliance configurations within the system;

FIG. 2 is a block diagram that illustrates an open network system in accordance with the present invention;

FIG. 3 is a block diagram that illustrates an overview of a payment transaction component;

FIG. 4 is a block diagram illustrating the integration platform as a service (IPaaS);

FIG. 5 is a block diagram of a management system having a blockchain structure;

FIG. 6 is a block diagram of an example of agnostic platform services that can be implemented in accordance with various embodiments of the invention;

FIG. 7 is a block diagram of another embodiment of the invention including a marketplace portal;

FIG. 8 is a block diagram of a further embodiment of the present invention including zero knowledge proofs;

FIG. 9 is a block diagram of another embodiment of the present invention including microservices architecture recommendations;

FIG. 10 is a block diagram of a further embodiment of the present invention including an identity federation, IDAM, and token-based authentication;

FIG. 11 is a block diagram of a further embodiment of the present invention including an Inter-Service Communication;

FIG. 12 is a block diagram of a further embodiment of the present invention including an order processing use case in microservices;

FIG. 13 is a block diagram of a further embodiment of the present invention including service mesh; and

FIGS. 14-16 are block diagrams of further embodiments of the present invention illustrating an Integration Platform-as-a-Service (IPaaS) of the platform.

### DETAILED DESCRIPTION OF THE VARIOUS EMBODIMENTS

The present systems and methods include various embodiments of blockchain technology with verification through a consortium of stakeholders. The consortium includes an association of several business companies who participate in an industry. The information shares on blockchain and centralized databases. The system can include either one-party lead or joint venture consortium.

The present invention can various applications and services to provide a solution to the problems found in the industries. In particular, the system provides visibility, track and traceability to the various providers, buyers, and other stakeholders in a supply chain. The system can be built on a platform using a software engine or computer framework. The platform can use custom Integration Platform as a Service (IPaaS) with infrastructure as a code or Platform as a code to manage the infrastructure through configuration files and also provision the tools and technologies to use. The platform can manage cloud resources by statically defining and declaring resources in code, then deploying and dynamically maintaining resources via code.

The blockchain technology, such as Algorand mainnet, can be integrated with the platform to leverage asset issuance, KYC metadata, and co-chain pegging. Visibility has been a central gating issue for supply chain management, typically having limited visibility at the “N minus 1” where one can only see the previous and next levels in the supply chain. In the present invention, the supply chain data housed on a blockchain-based platform can interlink and validate stakeholders in specific industry supply chains and can enable users to view and interact on the entire supply chain at any given moment in time. This visibility in the system solves the “N minus 1” problem by providing visibility in the entire supply chain at any given moment (i.e. N minus 2, N minus 3, N plus 2, N plus 3) and providing the use of shared data between “public” and “private” chains. The platform is architected to provide selective permissions to allow for shared data between “public” and “private” chains to allow greater supply chain visibility. The platform is an industry-agnostic, blockchain-enabled Supply Chain as a Service platform (SCaaS) that provides tools for companies to securely, efficiently, and reliably run their businesses.

The hemp industry is rapidly growing and is emerging as a strategic agricultural sector driven by products that are being processed into fuels, plastics, solvents, building materials, foods, and medicines, among others. Industrial hemp is also a powerful tool in the global effort to combat climate change - an acre of hemp sequesters more carbon than an acre of rainforest.

Voluntary carbon markets allow private investors, governments, and companies to offset their CO2 and other greenhouse gasses by purchasing carbon credits, each equivalent to a one-ton reduction in the amount of carbon in the atmosphere. Increasing numbers of companies are committing to ‘Net Zero’ carbon emissions (in line with the Paris Climate Agreement), and for more polluting industries (e.g., mining, aviation, construction) carbon offsets are an important part of the mix, along with carbon reductions.

Carbon offset purchases are also increasing as ESG (Environmental, Social and Governance) considerations are becoming more important to shareholders, customers and other stakeholders alike. The cumulative volume of the voluntary carbon market exceeded 1.3 billion meters of CO2 equivalent in 2019, with a value of more than $5.5 billion dollars. This market is expected to grow 15 times by 2030 just to keep up with the commitments made at the 2015 United Nations Climate Change Conference at Paris, with an estimated market size of $250 billion by 2050. Over the past year, the prices of compensation associated with Nature-Based Solutions (NBS) such as forestry and biochar, for example, have risen by 30%, with new methodologies in this space (along with renewable farming practices and soil capture) being developed every year.

Industrial hemp is a rapidly growing industry driven by a crop that is separate and distinct from its biological relatives that produce THC-based cannabis products as it contains less than 0.3% THC by dry weight. Its cultivation and production fully comply with all federal and state laws. Industrial hemp can be processed into over 50,000 uses including fuels, plastics, solvents, building materials, foods, and medicines and is also a powerful tool in the global effort to combat climate change because an acre of hemp sequesters more carbon than an acre of rainforest, and takes only months to grow an acre of hemp versus more than a dozen years to grow an acre of rainforest.

Currently, the hemp supply chain is in a state of disarray. It is characterized by opacity, fragmentation, lack of reliable payment systems, the inability to verify “real” buyers and sellers, and the inability to verify product provenance and quality according to federal and state regulatory requirements. Its highly decentralized farming community also suffers from an inefficient method of sourcing the labor necessary for sustained continuity of operations. Owing to its relative immaturity, the industrial hemp industry is underserved by a supply-chain solution targeting its needs.

The platform is designed with an Application Programming Interface (API), using microservices and web-services to blockchain-enable a wide range of legacy client-server supply chain applications. The blockchain technology brings significant new value to supply chain solutions for many reasons, including greater resiliency and a higher degree of data integrity. The platform can be inherently industry agnostic and therefore available to support greater value creation across a wide spectrum of use cases. Working closely with the industry leaders, the system can be built on a blockchain technology, such as Algorand.

A supply chain-related issue facing the hemp industry is the capability of tracking and tracing the sequence of processes involved in the production and distribution of the hemp-based commodities. The platform links participants in the supply chain and proves provenance and quality for any product that moves through the chain. Currently, there is limited penetration in the hemp industry of any robust track and trace technology. Thus, one component of the platform can include a module that will include a Key Performance Indicator (KPI) for track and trace capabilities. The system can ensure trust between industry participants including cultivators, processors, manufacturers, and end-consumers through verification of pertinent credentials, licenses, and certifications. The system can provide track and trace, with focus on carbon tracking, and the issuance of digital tokens that can be sold as carbon offset credits and traded worldwide. Additionally, the system can provide carbon-sequestration tracking throughout the hemp supply chain, provide route-optimization recommendations, and offer carbon offsetting investment platforms to companies for a given market.

In addition, the system can track provenance by recording the chain of custody for all raw and processed materials moving through the chain. Furthermore, the system can track quality by recording product quality information.

In another embodiment of the system, the track and trace capabilities can be extended to include participation from propagators, retailers, testing labs, distributors, and possibly brokers through inventory management, logistics, and order management. Labor on Demand (LOD) and Human Capital Management (HCM) capabilities can be deployed through an additional follow-on module that can deliver time and labor management as well as basic analytics. The solution can include scheduling, timekeeping error handling, and processing of hourly employees' records to payroll per hour, per day, per week or pay period, for both internal or temporary employees otherwise known as “Gig-Work”.

The system can be a complete supply-chain-as-a-service solution for the industrial hemp industry that includes modules for manufacturing, marketplace matching, expanded analytics using machine learning and artificial intelligence, payment systems, investments, supply planning, and demand management. The solution can address often cited issues by industry participants and analysts including difficulty in identifying who is in the industry, that people do not have adequate information to verify the source or quality of the products that they are buying or selling. The quality and traceability are ongoing challenges. The system provides the needed brand transparency.

The data in the system can also be used to provide evidence for product quality to tell human stories, to connect end consumers to the people behind the products, and to help businesses predict and prevent shocks disruptive to their business. The potential economic effects of a resilient supply chain are substantial. Some of the most significant costs in any supply chain are the cost of networking companies and resources, and the cost of verifying products as well as buyers and sellers.

The system may also include business networking. The network may incorporate suppliers, distributors, transporters, laboratories, state regulators, manufacturers, customers, and all other parties who pertinent to the procurement and production of goods and services for an industry. The system can create, update, delete, and modify personal profile data relating to business services, industry or otherwise specializations, contact information, profile picture, business description, and contact information. The system may also include a communication network that has consortium members and the capability to communicate with each other. This includes SMS/text message, email, and other communication software including both public and private message boards, forums, and internal messaging services.

The system includes a platform that interlinks market participants with each other within the supply chain and enables stakeholders to generate and review relevant market data. The system can also validate information and participants and verify product provenance, consistency, and quality. Transactions with others can be conducted through the system transact easily with others, and access tools for regulatory compliance and certification.

The system may include the ability to list products for sale; ability to complete a sale and transfer of inventory or products to other consortium members and any other external party; and ability to create sub-networks under the hood of the consortium. The system can map out product and inventory scenarios with other consortium members and extra-consortium parties.

The system may also include verification services. The verification services can be configured for an onboarding process wherein a business entity or other user uploads documents proving one's ability to participate in an industry. The onboarding process may include a business entity or user provides documents identifying who they are. The onboarding process may also include a business entity or other user that provides the public-key of a key pair. The key pair can be produced either on a blockchain or delivered by Certificate Authority (CA) or any other method whereby a key pair can be generated.

The system may also include a compliance component. The compliance component may have regulatory agencies and other members of the consortium connected to view and verify the certification of any other regulatory agency or member of the consortium. The members can be any user that is part of the consortium system.

A track and trace component may also be part of the system. The stakeholders on a supply chain can track and trace the aspects of a supply chain including a payment solution where users are able to validate participants, verify products, transact business with others, and have access to portals for regulatory compliance. This platform is architected to provide selective permissions to allow access to shared data between “public” and “private” chains for greater supply chain visibility. In the track and trace component, inventory transfers between members of the consortium and external transfers of inventory to extra-consortium users and/or business entities are recorded on the blockchain. Inventory transfers may be interlinked through a blockchain transaction protocol that includes smart contracts designed to store IDs or hashes of data/media/IDs that link back to a centralized database where inventory transactions and attributes are stored. Centralized data may include the following: specific inventory attributes, dates, locations, geo-coordinates, and any other data necessary for the correct classification of inventory being transferred including information about who transferred the inventory and who receives the inventory and which transactions and smart contracts and other blockchain assets gave provenance to said inventory. The inventory transfers can also be interlinked through a blockchain transaction protocol that includes smart contracts designed to store specific inventory attributes, dates, locations, geo-coordinates, and any other data necessary for the correct classification of inventory being transferred including information about who transferred the inventory and who receives the inventory and which transactions and smart contracts and other blockchain assets gave provenance to said inventory.

External reports relating to inventory are transferred into the consortium through the blockchain. Reports may be anything related to the validity of the inventory or product including but not limited to lab reports and other supporting documents needed to comply with state, federal, and any other regulator pertaining to the industry. Reports can be encoded in the blockchain in both text, media, and any other formats needed for the recording of data attributable to inventory. Other formats refer to all MIME types as defined by the Internet Engineering Task Force (IETF) and the consensus of the IETF community. The specification and registration of media types for use in HTTP, MIME, and other Internet protocols are defined by the IETF, which is understood by those skilled in the art. These standards are found at https://www.iana.org/assignments/media-types/media-types.xhtml, which are hereby incorporated by reference.

Consortium members and extra-consortium participants can use a web portal or native mobile portal or email service or any other Application Programming Interface (API) service or Graphical User Interface (GUI) portal created electronically or otherwise, including paper format, to track inventory, reports, certificates, transfers of inventory, data analytics, and any other action that was recording on the blockchain. Consortium members and extra-consortium participants can view the hierarchical linking of transactions through the methods and data.

In another embodiment of the invention, the system can include a stable coin component. With the stable coin blockchain-native currency with a value can be pegged to the U.S. currency (U.S. Dollars). The system can also include coin as a monetary unit for participants in the consortium to trade goods. Know Your Customer (KYC) and Anti-money Laundering (AML) compliance may be handled by a member bank. Coins can be transferred, tracked and traced through separate blockchain to record immutable audit trail. Coins can be converted to U.S. Dollars or other currencies supported by the member bank. Coins may be represented in the blockchain as the economic unit of value for inventory, actions, agreements, or similar methods. Coins can be transferred out of the Consortium through blockchain oracles to other blockchains or coin denominations. Coins can be transferred into the Consortium from the partner bank or from external/internal blockchain technology from extra-Consortium sources including other blockchains and other extra-Consortium Consortiums.

The system can also include Integration Platform as a Service (IPaaS) components with different applications and services. PaaS/Oracles may tie existing Enterprise Resource Planning (ERP) or Supply Chain Management (SCM) outside the ERP platform (i.e., SAP, Oracle, IBM, and similar providers) into the track and trace technology. Blockchain oracles and other APIs and data transfer methods can transfer information from private blockchain or other public blockchains into and outside the consortium. This may include additional external consortium's and related blockchains. Blockchain oracles and other APIs and data transfer methods can transfer data to external or internal centralized databases. Blockchain oracles and other APIs and data can include transfer methods to read, write, update, replace, and delete data on any centralized, decentralized, or blockchain networks and databases both inside the consortium and outside the consortium including to external consortiums. Inter-transfer logic can allow for re-routing of data in inflight to an indeterminate number of centralized, decentralized, or blockchain networks and databases.

The system can also include a Supply Chain Management (SCM) component. Material Requirements Planning (MRP) or Demand-Driven Material Requirements Planning (DDMRP) SCM may be included with the capability of cross-enterprise (Consortium member) collaboration and interoperability, such as, data sharing, and population and recording of relevant data for richer, internal, and permissioned track and trace for both product provenance and inventory transfers between Consortium members and to/from extra-consortium systems through blockchain technology or the like.

FIG. 1 illustrates an overview of the data, traceability and compliance configurations within the system. The system uses blockchain technology to communicate information between users in the supply chain. For instance, the seed growers, farmers, processors, and transporters can input data that based on their specific role in the process. The data from one user is linked to the data from other users to provide a history of the product when exchanged from user to user. The data is compiled throughout process of manufacturing and distributing. The participants such as seed growers, farmers, processors, and transits will integrate with regulators and laboratories to receive verification. By using blockchains, the data can be linked to regulators for verification and laboratories to issue certificates. The laboratories can test the legitimacy of the hemp products produced by the participants, guaranteeing safe and reliable production. The regulators can verify compliance with the regulations and participants can use the system to grant licenses. The blockchain, such as an Algorand blockchain, that is created between the participants, the regulators, and laboratories creates a simple method for compliance and verification. The side-chain can be Hyperledger Burrow or Besu, both have embedded EVM and thus are Ethereum capable. Many high quality, open source audited contracts are available, for ZKP, Traceability, DeFi and ERP integration (baseline), These innovations will be deployed in the side-chain.

The platform interlinks market participants in the hemp supply chain. The stakeholders can generate and review relevant market data through the platform. The system assists users to validate information and validate participants that are stakeholders in a particular chain of data. The products can be verified for provenance, consistency, and quality. The platform also can provide accessible tools for regulatory compliance and certifications.

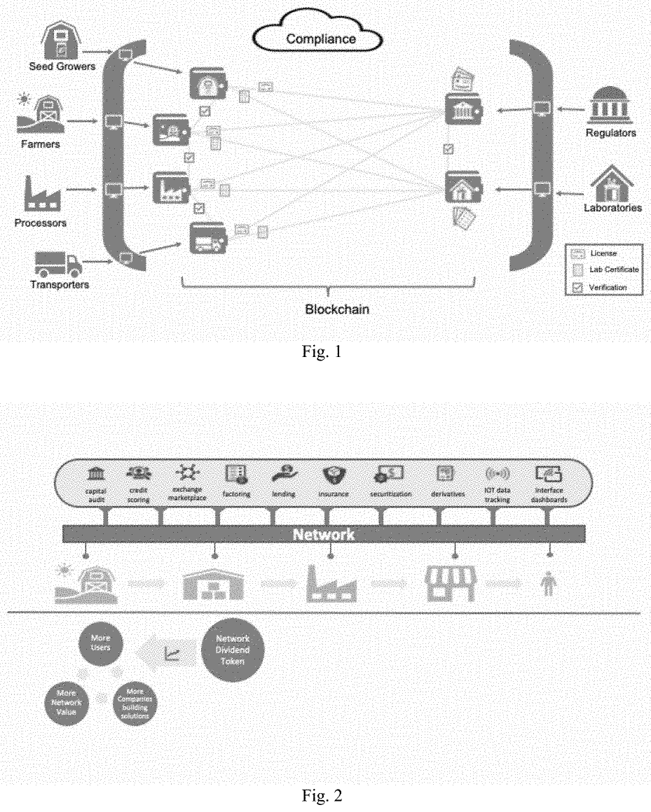

FIG. 2 illustrates an open network system in accordance with the present invention. An open system allows for the combination of network effect, interoperation, and financial engineering. The different network contributors such as capital auditors, credit scoring, exchange marketplaces, factoring, lending, insurance, securitization, derivatives, IOT data tracking, and interface dashboards can access and/or provide data associated with the product and contribution towards the growth of the open network. The network effect can be exacerbated by introducing token incentives that can pay a percentage of the network revenue as dividends. Since the platform is built on an open network, other companies are able to build solutions for participants of the supply chain. The network dividend tokens provides incentives for users which can lead to more companies building solutions resulting in more network value which cycles back to more users. The use of a cryptocurrency, such as Stablecoin, can increase the popularity of investment and growth within the hemp industry.

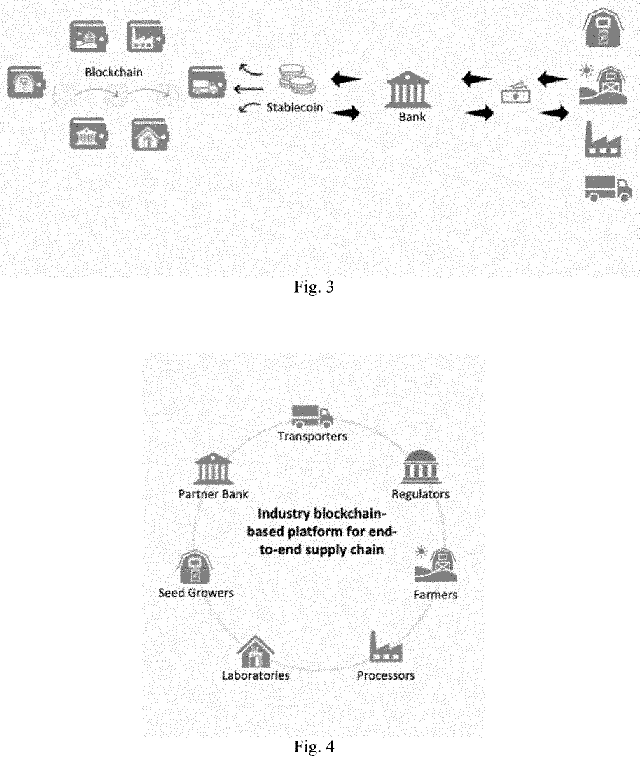

As illustrated in FIG. 3, the platform can have a payment transaction component. The system can include a payment transaction component that uses a cryptocurrency, such as Stablecoin, to conduct business between the stakeholders. The cryptocurrency provides opportunities for further investment and growth in the industries. The stakeholders can use the cryptocurrency to make payments throughout the manufacturing process. For example, the farmers can pay the seed growers, and the manufacturers can pay the farmers for the raw product through the platform. Banks can back the circulation of the cryptocurrency. In addition, hemp companies can invest in the cryptocurrency to allow for the increase of industrial growth.

FIG. 4 shows the overview of the integration platform as a service (IPaaS). The integration platform and supply chain software are a modular cloud-based management system that allows for data analytics and organization. The platform can include ERP, SaaS a modular Supply Chain Management (SCM) system and Data Analytics platform. The system will be operated with a platform neutrality. Other systems, such as IPaaS and Oracles, can be configured to tie into existing ERP and SCM programs outside of the platform to connect into the track and trace technology.

The system can implement MRP/DDMRP SCM with the capability of cross-enterprise collaboration and interoperability, for instance, data sharing, and population and recording of relevant data for richer, internal, and permissioned track and trace for both product provenance and inventory transfers between consortium participants and to and from extra-consortium systems.

Data analytics can be integrated with the platform to track consortium, industry-wide health to inform consortium, industry, and individual enterprise-wide decision making. The software provides agreed-upon technical architecture, platform neutrality, and track and trace technology. The connection between every step of manufacturing hemp, through the platform, is monitored and tracked by data sharing and permissioned track and race for both product provenance and inventory transfers between consortium participants and to extra-consortium systems.

The information is tracked in the platform. When product changes hands or a process is completed, the information can be stored in the blockchain and can include verification information. The information can be sent with the product to the retail market to provide a reference for customers to know the source of the products and to trace data back to the origin, for instance, the origin of the seeds. The products can include a scannable QR code to provide information from the blockchain, such as data related to the inventory transferred or verification of lab reports and the like. In addition, QR codes can be implanted with a link to allow users to provide date, like the providence of the product, to potential buyers.

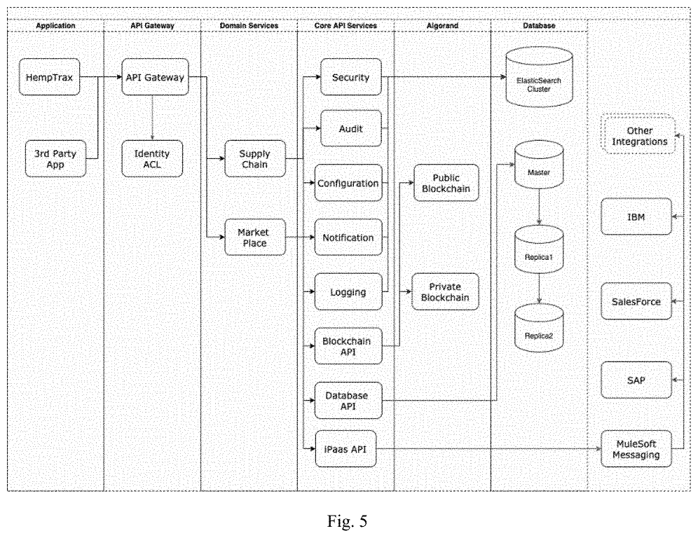

The system is shown in FIG. 5 with the various devices and components. The platform can be built on a software application, which can incorporate, integrate with or share information with other third-party applications. The data can be shared through an API gateway after verification through an identity Access-Control List (ACL). After versification, the users can access the domain services and core API services through the supply chain and/or the marketplace. The API services can include security, audit, configuration, notification, logging, blockchain API, database API, IPaaS API, and other API services associated with the platform. The blockchain can be divided into a public and private blockchain to allow access to certain data by stakeholders. This way, some information or attributes can remain private and not accessible by all users.

The blockchain database can include an Elasticsearch cluster, a master database, and multiple replica databases. FIG. 5 shows replical and replica2 database as backup databases. Although two replicas are illustrated, more databases and can be used in the system. The images are used for illustrative purposes.

The platform can run with other third-party systems or integrations, such as IBM, Salesforce, SAP, Mulesoft Messaging, and other provider services. These services can be integrated with the platform to provide additional benefits and aspects for the users.

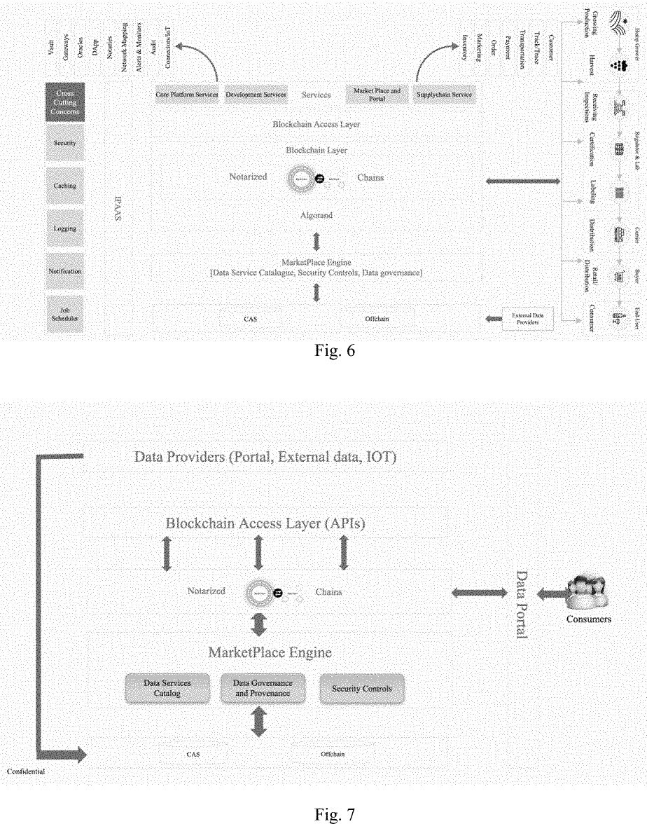

FIG. 6 illustrates an example of agnostic platform services that can be implemented in accordance with various embodiments of the invention. The platform can integrate with various types of services including, for example, core platform-based services, supply chain-based services, marketplace-based services and development-based services. These services as well as their features can be implemented with the platform.

The core platform-based services can include a set of services configured to allow users to develop, run, and manage applications within the platform infrastructure. Some examples of core platform-based services can include decentralized applications (DApp), notaries, Oracles, alerts, monitoring, gateways, QR Codes, connectors, process management engine & service orchestration, network mapping, and vault (such as identity, asset, and trade).

The Supply Chain as a Service (SCaaS), in accordance with the various aspects of the invention, can include a platform having a blockchain based ecosystem that aims to make supply chains more transparent, efficient, and accessible by offering a supply-chain-as-a-service platform to enterprises and consumers. The SCaaS of the platform can include many services within the broad scope of tools offered for supply chain technology solutions. The solutions can be integrated under one platform to deliver an affordable solution. These solutions can be cost effective alternatives that can be automated through blockchain technology and scaled for a wide spectrum of solutions for other businesses and service providers on the platform.

The platform can also include development services. A Software Development Kit (SDK) and development interface can be provided for technology partners, organizations or individual developers who can create applications or provide services on top of the platform Core Layer for users, such as Trading Partners.

A marketplace may also be integrated into the system. A marketplace is a platform where platform or service providers can offer their data, services or assets for a price. Consumers can purchase or subscribe to such assets and use the assets for their consumption and business purpose. The marketplace itself can be hosted by the platform and offer a secure place for such exchanges to occur. The marketplace can be expendable to partner with and leverage other marketplaces with the platform.

As shown in FIG. 7, the platform is illustrated having a marketplace portal. To handle the large volume of data required to store the user inputted information, the platform can have access to a large volume, variety and location of data storage. The data storage should also have security measures that are sufficient for the confidentiality and sensitivity of data being stored. Given the potential latency within blockchains, the platform can use storage outside of the actual on-chain to store certain data. Data that does not require verification, can be stored off-chain—meaning, external storage outside of the blockchain. For this purpose, a third-party cloud-based data storage option can be integrated into the platform to handle some of the potential storage and latency issues. The “Variety” factor can also determine which storage option is used since not all data on the marketplace may be structured. A significant portion of the data may be unstructured data.

The data can be encrypted at rest and the access can be controlled using role-based access mechanisms like JSON web tokens (JWT), Open Authorization (OAuth), or compact and self-contained methods of securely transmitting information between parties.

For the marketplace to function effectively when using on-chain and off-chain databases, the connecting glue between the on-chain data and the off-chain data can include unified security, governance, management and visibility across all data sets. This unification of the data brings forth a seamless and unified data plane. To achieve the purpose, the platform can include a data catalog, security controls, data governance, a blockchain access layer, and a data portal. The data catalog provides discoverable and searchable data across multiple data sources. The security controls help protect the potentially sensitive data sets based on the ecosystem. These data plane services include unified security across multiple data sets to grant access to the right users for the right data sets within the right context. End-to-end data governance is used in the world of General Data Protection Regulation (GDPR) and other such compliance. Data governance can be used to understand who accessed what, who changed what, when data was edited, and so forth. There are multiple protocols or mechanisms through which a blockchain platform can be accessed. Standardizing on a common access layer that leverages APIs makes the blockchain access layer easier for the community to use. The data portal can be the marketplace portal that the data providers and the data consumers can use to either input data for sale or checkout data for purchase.

To efficiently use the on-chain data resources, the anonymized transaction data references can be made available on the blockchain database, while writing other data to an off-chain database. Supporting transaction data can be notarized on-chain and archived in a secured data vault. The off-chain data referenced by the transaction can be accessed by a secured role-based https REST API. Asset digitization can be allowed by only authorized service providers, for example, Digital USD can be issued by FED Licensed service providers like Circle and Paxos.

The Asset Owners are the physical holder of the asset. For example, a farmer owns her stock until the stock is sold and control is transferred to the buyer. If unsold stock is financed (as a collateral for a working capital loan), the stock can be held in a warehouse. The ownership can be reflected as the financial institution on the digital ledger backed by warehousing receipts and bank transaction trails.

It may be noted that the asset owner may not be a direct participant in blockchain transactions. In this case, the asset owner can submit the data to a Digital Assets Manager, who can prepare the data as per compliance rules, validate the data, send to a digital vault service and a digital notary and then create or transfer the asset on the distributed ledger on the blockchain as well as make the data available to role-based data access off-chain.

Authorized institutions can create specific asset types. For example, FinTech partners can issue Digital Dollars like Paxos and Circle. The asset creators can be responsible for data vaulting and notarization of the backing data for the full asset lifecycle. An auctioning service may facilitate price discovery and negotiations and then facilitate the order to cash cycle and reflect the transaction on the blockchain.

Know Your Customer (KYC) and Certificate validators can be specialized Digital Asset management service providers that facilitate anonymized Zero-Knowledge Proof (ZKP) of on chain identity. The Legal Identity Identifier (LEI) is verified and stored off-chain. This service issues an anonymized on-chain transaction ID containing the Zero Knowledge Proof of Set membership (ZKSMP) and Zero Knowledge Range Proofs (Merkle Root/ZKRP) of the backing KYC data. Notarization also follows a similar process.

KYC/Certificate validators can digitize, through a process like scanning, the physical paper document. The certificate can be stored in the database and accessed by the users as a source of verification. Additional data verification may be required when the ownership of a specific document changes or may be invalidated by subsequent transfer of ownership of an asset. The physical document can be Dematerized before invalidation. This information can be recorded on the blockchain.

Notaries can be “blind notaries” to add an additional layer of validation. In this method, a notary can be presented with a Transaction Hash to be notarized along with a Zero Knowledge Proof of Set membership (ZKSMP). The notary when charging a fee, the transaction can be handled on-chain by a smart contract.

The data vaulting component can be stored off-chain. The proof of storage for the data vaulting can be issued on-chain for validation purposes. The data can be submitted for archive and compliance via an API or other file transfer protocol. The fee payment can be transacted on-chain to serve as a proof of data vaulting. The data vaulting and notarization can be on-chain to co-relate the data vaulting and notarization by any unauthorized third-party.

The assets may be fungible financial assets or non-fungible assets. Fungible financial Assets can include Digitalized (tokenized) USD, also referred as Collateralized Digital Tokens. Non-Fungible Assets can include tokenized produce or product batches. The ownership and issuance can be separate. A farmer, for example, may want to auction her stock in the platform. For this purpose, she presents all the evidence related to the product and produce parameters, by way of certifications, licenses of the product or produce.

If LEI KYC onboarding is not completed, then this process is carried out when assets are presented in the marketplace. The system verifies that each step of the on-chain Asset lifecycle has a transaction ID of the on-chain Notarized data. Prior to asset digitization, the physical assets creator or owner can maintain their own data digital trail. The assets can also be optionally notarized and vaulted.

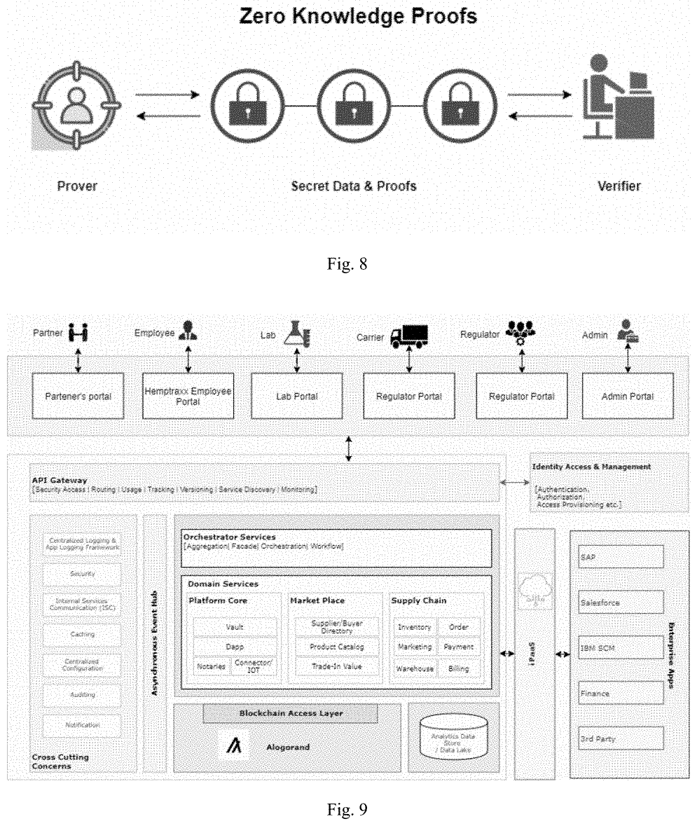

FIG. 8 illustrates Zero Knowledge Proofs. A record can be stored in a permissioned CAS. The key is a merkle root of the record. The link to the document of the KYC record, the transaction ID, and block height of the record can be sent to the entity being on-boarded. At this point the entity can be deemed to be whitelisted. The KYC entity can be authenticated initially. The system will then notarize the licenses from the entity to authorize transaction roles on the platform. In case of any serious regulatory violation, the entity can be removed from the whitelist by sending a transaction to the blockchain that can update the original KYC validity status of the stateful smart contract.

As different states in the United States of America have varying states of digital readiness, some states still issue paper-based certificates. These paper-based certificates can be digitized and notarized by the Trust Providers. Digitally signed regulatory certificates can directly be notarized and recorded on the blockchain.

Various legal entities (participants) transacting on the platform will have varying levels of digital readiness and Information Technology infrastructure capabilities. While some participants may be able and willing to manage their own blockchain public key pair, others may be unable or unwilling to manage their public key. In such cases, as the participants may opt to not have a direct blockchain presence, they can transact via the Self-Service Portal, referred to as Off-Chain Legal Entities. The presence of the Off-Chain Legal Entities can be recorded as a delegated signature stateful smart contract pointing to a Re-Keyed account. The blockchain technology can include a Rekeying feature.

After the delegated signature smart contract is created, a temp key can be created, which can be generated using a random number. This key can be funded with a minimum required ALGO for creating a key. Once these transactions are confirmed, a ReKey transaction can be sent to the network. The temp key Private Key and generation seed can be expunged from the memory and forgotten. The KYC stateful contract can have reference to this re-keyed address. In case of on-chain entities, they can manage their own blockchain key. The public key can be recorded on the KYC stateful contract. Thus, an off-chain entity may decide to become an on-chain entity, after due diligence and re-Notarization of the Blockchain Key, the original address can be re-keyed. The delegated authority smart contract can be invalidated by sending a Delete Application transaction to this contract. The transition from Off to On Chain LEI will be achieved via sending a ReKey Transaction, after due diligence by the Notary.

The Technology-Enabled Active Learning (TEAL) bytecode plus the length of any Args should add up to less than 1000 bytes (consensus parameter LogicSigMaxSize). Each TEAL op has an associated cost estimate, and the program cost estimate must total less than 20000 (consensus parameter LogicSigMaxCost). To avoid overflow and parametric complexity, each on-chain reference of the off-chain data structures, will be passed as following Triac: URL of the data access REST API (optional) not required for on-chain transactions ID; Schema URI is the Data structure associated with the reference ID; and Reference ID is a base64 encoded binary string.

To retrieve the data from the URL, chain-id, transaction ID, and Reference ID should be passed as GET parameter, along with a self-signed Java Web Signation (JWS) signed with the associated class 1 digital signature associated with KYC.

FIG. 9 illustrates Microservices Architecture Recommendations within the system. The description of microservice components for the platform can use microservices architecture. Portals can allow End-users to communicate with the microservice platform, possibly across multiple channels, such as Web, Mobile or Kiosk, and eventually across different devices. Portals can make use of the services exposed by the API Management layer, in the form of REST APIs in order to consume information or execute operations.

The API Management layer can have the capability for exposing proxies for the “real” APIs that are implemented and exposed on the orchestration microservice layer. The reason for having proxies is that they enforce not only the security for an API by means of implementing authentication and authorization for an API, but also, they implement other features, such as throttling, traffic filtering, caching, mocking and monetization as well, just to mention some of them. By letting external consumers to hit the proxy instead of the “real” API implementation—which remains protected—represents higher security and overall microservice hardening.

Microservice-based APIs sitting on the orchestration microservices layer implement the specific logic related to the orchestration of one or more domain microservices, typically belonging to separate domains via API calls. To fulfill an order, for example, the order orchestrator may call an inventory domain microservice and a billing domain microservice.

Domain microservices represent business-specific specialized microservices, which implement the specific business logic associated with the execution of certain core business operations, usually tied to a single responsibility, and usually own data to a certain extent. They are grouped together into separate logical partitions called “domains”, being each domain then a set of individual microservices which have a high level of cohesion between them in terms of functionality. Microservices, for example, that solve inventory management are grouped logically into a separate “inventory domain.” Domain microservices expose APIs to the orchestration layer, but use event sourcing to communicate between them, either inside the same domain (intra-domain events) or across different domains (inter-domain events), or to communicate with the abstract microservices on the integration microservices layer.

The Asynchronous Event Hub is a centerpiece in the event-driven architecture. Events flow through the asynchronous event hub, on which event publishers and subscribers (abstract and domain microservices) are sourcing and ingesting events in real time. Microservices talk to the asynchronous event hub to interchange events following event-driven messaging.

Identity and access management represents a software solution which integrates with the API Management to provide centralized authentication and authorization for APIs exposed to external consumers through the Next-Gen UI. DAM solution should be able to handle token-based authentication, role-based access control (RBAC), and identity federation.

Cross-Cutting concerns represent a set of features and capabilities that can be Orchestration Microservices made available to the microservices and offered as part of the platform services implementation. Common Cross-Cutting concerns include the ability for logging, distributed tracing, distributed caching, centralized configuration, monitoring, auditing, alerting, service discovery and registry. The central concept behind Cross-Cutting is that they are built and configured once, and re-used many times by the different components across the microservice reference model which reduces the cost and complexity of having to build them separately for every single microservice being deployed.

The system authenticates user requests and checks authorization at each microservice call. The system can use Virtual Private Cloud (VPC) instead of exposing services to the public network. In case going for traditional OVH or Rackspace, services can be put behind virtual firewalls or DMZ. Public facing microservices are protected by the API Gateway using an authentication mechanism.

The system can use JWT for inter microservice communication. JWT tokens provide better performance as they contain required information within themselves and do not require a round-trip to the authorization server for validation. The system can use secure endpoints with strong encryption, especially the endpoints that are exposing sensitive data. The system can also obfuscate sensitive data before persisting the date to the database. In addition, the system can avoid logging of secrets and sensitive data. The security includes implementing authentication, authorization and threat modelling strategy. The claims-based authorization can accommodate the requirement to support federated authorization. A claim can include identity, role, permissions, and rights.

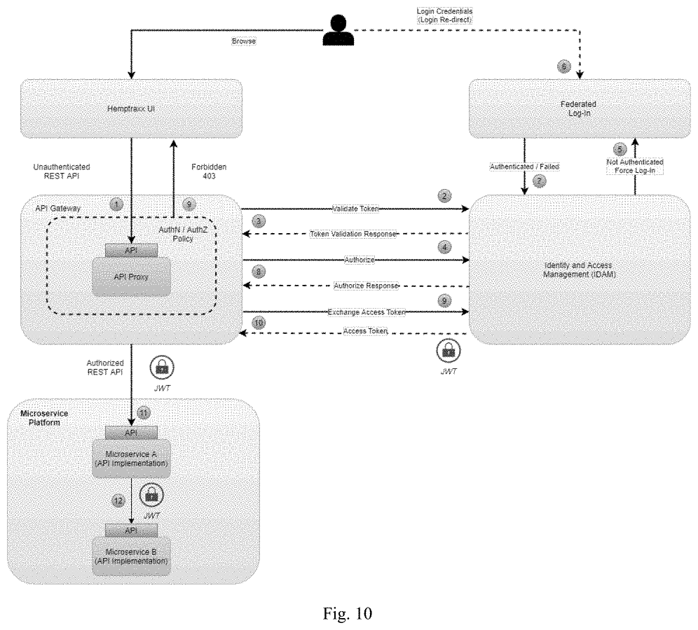

FIG. 10 illustrates an identity federation, IDAM, and token-based authentication in accordance with a further embodiment of the invention. A REST API Proxy endpoint can be invoked by the UI in the context of a certain use case. The API Proxy can be protected by an authentication or authorization policy in the API Gateway. The API Gateway forces the API to be authenticated before proceeding to call the microservice API. The authentication or authorization policy can be configured to work with an IDAM via OAUTH2 by using authorization code grant type. A validation API can be called on the IDAM to get the current request's token validated. The IDAM validates the token, and then sends back a token validation response to the API Gateway, either it was successful or failed. If the token is not present (i.e., first call to the API on the user session), then a TOKEN NOT PRESENT response can also be sent back, indicating such a condition. If the result of token validation is FAILED, then the request is be authorized. An authorized request is sent from the API Gateway to the IDAM's specific authorized service endpoint. If otherwise the result of validation is SUCCEEDED, then no further actions are required, and the API Gateway can then forward the request to the specific microservice implementation. Since the request is still not authenticated, the user is being redirected to a federated custom login page, assuming a single authentication factor.

The user can be redirected to the custom login page, where credentials can be provided for the specific challenge (username/password custom page). If the credentials were correct, the user is authenticated. Otherwise, it is a failed login. The IDAM performs RBAC checks to identify if the authenticated user has enough permissions to access the resource, and if that's the case an authorization code is being granted to the user. An authorized response is sent back from IDAM to the API Gateway, which contains the authorization code. The authorization code is exchanged by the API Gateway with the IDAM in order to get a JWT signed access token for the specific resource and user. The DAM checks the authorization code, and if everything is correct, it builds an access token that is being encapsulated in a JWT (Jason Web Token) format, and sent back to the API Gateway. Authorization is complete, request can now be forwarded to the specific microservice API implementation for execution.

The Platform can use microservices exchanges JWT token while in communication. Either authentication credentials were invalid or valid, but the authenticated user does not have proper permissions to access the API resource. An HTTP 403 status code is sent back to the client, indicating such a condition. No further actions are taken.

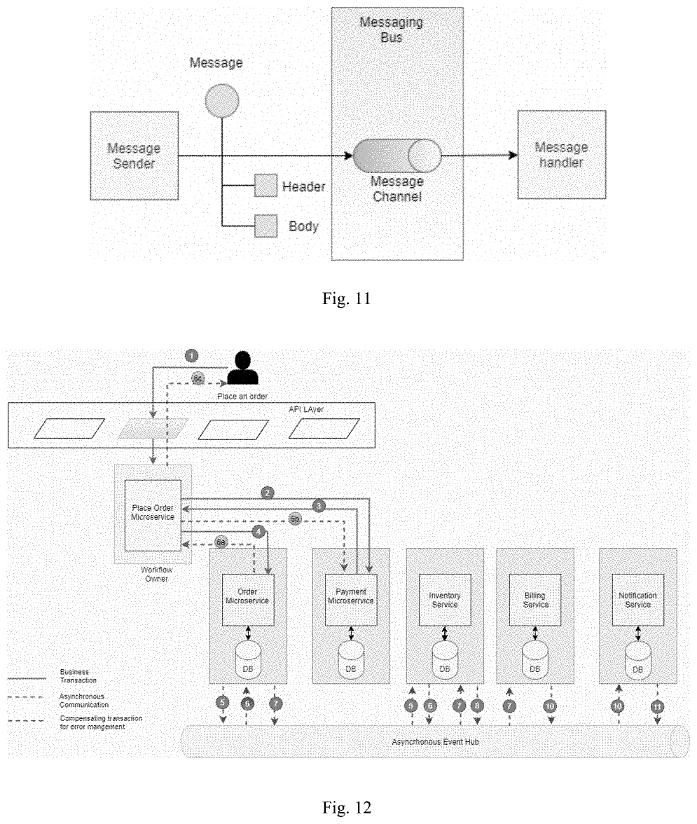

An Inter-Service Communication is shown in FIG. 11 with a message sender sending message via message channel. The inter-service communication can be achieved by either of the following mode: (a) event based: Asynchronous in nature and microservices communicate by publishing and subscribing events to Event Hub; or (b) Request/Response: Synchronous in nature and call remains blocked until the operation completes. Generally (Use Case) Orchestrator services call other services synchronously using REST APIs/ gRPC.

Event based communication uses “broadcast” events to communicate between microservices is the backbone of building a loosely coupled Microservices-based architecture. Events are “customer agnostic.” A change to a microservice cares only about its own internal state, and changes to it. It need not know about the existence of other Microservices.

Types of event: Events can be categorized as follows: (a) fact: Represents change in internal state of sender of the message or (b) commands: Triggers state change in another domain model by specifying the operation to invoke and its parameter. The messaging based communication has its own advantages and allows loose coupling between services. There are, however, areas in the architecture where it makes sense to use request/response communication to simplify the overall process. Event based communication would be leveraged in the platform wherever possible, considering the benefits like loose coupling and increased modifiability. It would also be useful to leverage request/response communication in the following scenarios: while communicating with user-facing components of the product, such as a client application, web browser, or mobile app. When you cannot rely on the eventually consistent state of other domain contexts; for example, to implement distributed transactions that require rollback.

FIG. 12 illustrates order processing use case in microservices. A user can place an order for a product through the platform. The request goes through the API gateway to “Place Order” orchestration microservice. The “Place Order” orchestration microservice initiates payment by invoking “Payment Microservice.” “Payment Microservice” completes payment processing, for instance, thru cryptocurrency. After successful payment “Place Order” orchestration microservice invokes “Order Microservice.” “Order Microservice” places the “Order Placed” event on the asynchronous event message hub. “Inventory Microservice” captures the “Order Placed” event and reserves the quantity of product for further order processing. The platform may use the blockchain internally to change the status of required quantities of products to reserved. The system sends an event called “Inventory reserved” and shows details to the user regarding order has been placed. In case the required quantity is not in inventory, the system sends an even back “Inventory lower” event. In such cases “Order Microservice” rollbacks the changes and the payment is reversed thru “Place Order” orchestration microservice. Order Microservice once captures “Inventory reserved” event from Inventory microservice, the system performs further processing and sends “Order confirmed” event. “Inventory” microservice captures “Order confirmed” events and deducts the inventory placed in the order. The service would use blockchain internally for inventory update. The “Inventory” microservice then sends “Inventory Updated” event. “Order Confirmed” event is also captured by Billing service to generate the bill. Once the bill is generated, it sends a “Bill generated” event. “Notification service” captures the event “Bill generated” and generates email notification to the buyer. Email is sent and “Notification service” sends an “Email sent” event.

FIG. 13 illustrates another example of the invention using service mesh. Business logic pertaining to communication can be coded into each service without a service mesh layer however as the number of services grows and communication level increases manifold, the system can become complex hence a service mesh becomes a valuable solution. For cloud-native apps built using microservices architecture, service mesh is the right consideration to encompass a large number of services into a functional rendering. Service mesh takes the logic governing service-to-service communication out of individual services and abstracts it to the infra layer. Requests are routed between microservices via proxies in the infrastructure layer. Individual proxies forming service mesh are called Sidecars as they run parallel to each service and not within them. These sidecar proxies are decoupled from each service and generally they constitute a mesh network.

In absence of a service mesh, microservices need to be coded with logic to govern service-to-service communication and hence this aspect should be managed within the services model. Communication failures or breaches are difficult to be diagnosed as logic that governs interservice communication is encapsulated within the services. Addition of new services can deteriorate the communication environment and introduces new points of possible failure. Within a complex microservices architecture, it can become nearly impossible to locate where problems have occurred without a service mesh. A service mesh provides service-to-service communication as dashboard reports.

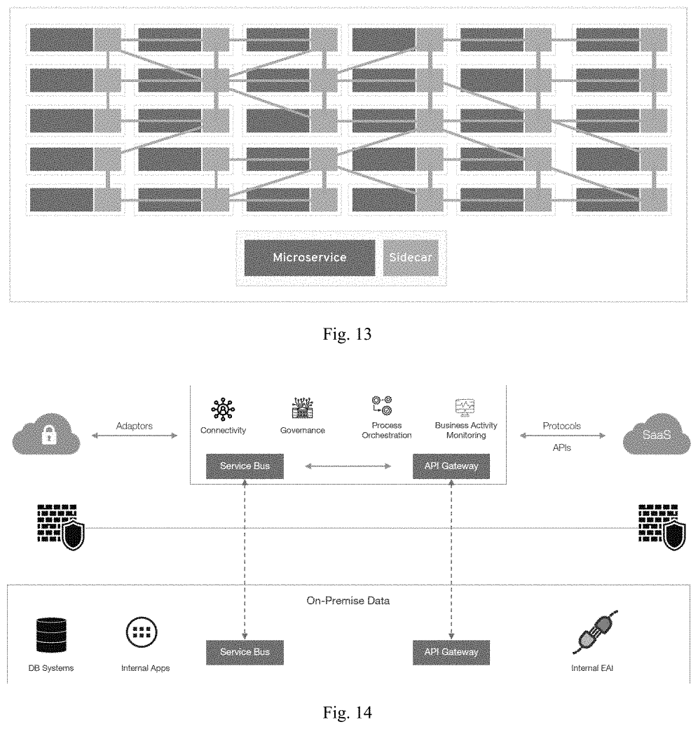

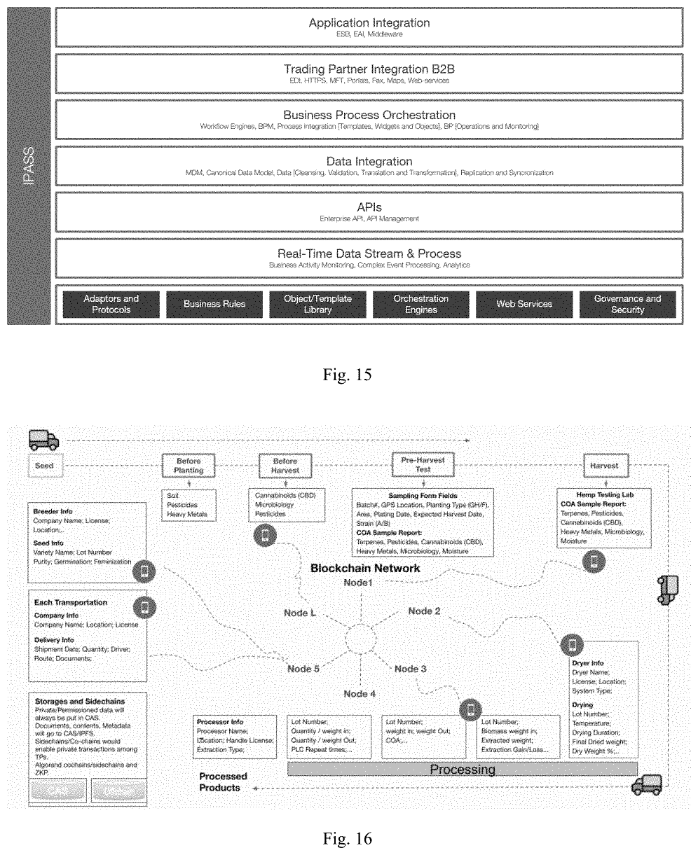

FIGS. 14-16 illustrate examples of the Integration Platform-as-a-Service (IPaaS) of the platform. The IPaaS can be an app integration solution that can integrate cloud-based platforms, web applications, mobile apps, IoT devices, and the like. The platform can be a single, centralized and simplified solution. The platform can combine integration capabilities together in one place and delivers a single, consistent structure for connecting all applications and data—whether on-premise, Cloud, mobile or IoT. The Platform can reduce time, cost and resources for integrating the application ecosystem within a given organization. The Platform is flexible and scalable to enable any-to-any connectivity (instead point-to-point) among systems through standard connections. The platform has improved operational efficiency by bringing tools and systems together over a single platform to improve the efficiency of business processes and workflows, and enables fast, reliable and effective access on information. The platform delivers on-demand and self-service with documented and eased customer experience for purchase/enable iPaaS features. Also, the platform can have pay-per-use or subscription-based charging model with complete transparency and visibility over usage and billing. The system is auto scalable with a true iPaaS platform to autoscale based on configurable rules and resource demand.

The platform can follow GS1 standards to enable traceability. The standards are found at: https://www.gs1.org/docs/traceability/Tracebility%20Schema%20v7b.pdf. Global standards for identifying and codifying items by giving each one a unique identifier. CAS to store Private and Permissioned data. The platform can use side-chains and co-chains to enable private communication among TPs.

Micro Frontend architect is a design approach in which a frontend application is decomposed into individual, semi-independent “microapps” working loosely together. Micro Frontend extends the concepts of micro services to the frontend world. The platform can use a feature-rich and powerful browser application, such as a single page app, which sits on top of a micro service architecture.

The benefits of the micro-frontend architecture include: a system that is highly scalable and upgradeable. Because of the modular structure, the platform can use micro frontend, which is highly scalable. Micro frontend can be upgraded to the latest technology ranging from web, mobile, Internet of Things, wearables or simply to a newer framework.

By creating small applications or modules, resources and teams can proficiently work in separate technologies in their isolated micro-frontend reducing the risk of conflicts, bugs, and deployment delays. Releasing micro-frontends become smooth by delivering small pieces of the application separately at any time without affecting others. In Micro frontend web apps are distributed in small chunks of services starting from the UI to API integration that works independently. So, even if one feature faces the issue, it doesn't affect the rest of the web app. And this feature makes it possible to recover from the error faster.

The system can include a microservices-based architecture that brings high levels of flexibility, robustness and resilience by supporting modular deployment and enforcing a loosely-coupled design. This is supported by this architectures' use of a fully event driven architecture (“EDA”) paradigm. An event-driven approach decouples services by broadcasting messages over an event bus, avoiding the coupling within solution.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A management system having a blockchain structure, the system comprising:
a consortium of stakeholder computers connected to a platform, the consortium of stakeholders providing user inputted data associated with product providence;
the platform being integrated with a blockchain database to verify and manage user inputted data, the platform being configured to validate and assign values to the user inputted data to connect to related data within the blockchain database; and
a user interface configured to display qualified data based on user search queries and focus search results to provide a roadmap of the data relevant to a particular product or value.

2. The management system of claim 1, wherein the qualified data that is displayed in the user interface includes track and trace information relevant to a user searched variable.

3. The management system of claim 1, wherein the user inputted data further comprising carbon credits associated with a product; wherein the platform validates and assigns a value to the product based on the user inputted data.

4. The management system of claim 3, wherein the user inputted data contains values for carbon credits associated with growing hemp, and wherein the platform calculates and divides values for the carbon offset credits based on attributes and stage of the products.

5. The management system of claim 4, wherein the platform issues digital tokens to stakeholders based on the values for carbon offset credits.

6. The management system of claim 1, wherein the platform validates credentials, licenses and certifications from user inputted data and attributes a value to the user inputted data based on criteria set by the system.

7. The management system of claim 1, wherein the platform tracks the product providence at a stage and assigns a product attribute to an associated blockchain.

8. The management system of claim 7, wherein the platform records a chain of custody in an associated blockchain for the product attribute.

9. The management system of claim 7, wherein the product attribute includes data associated with raw materials and processed materials and the stage of the materials at the time a value is assigned.

10. The management system of claim 9, wherein the product attribute includes values assigned to a product that is associated with a product information and quality.

11. A management system having a blockchain structure, the system comprising:
a consortium of stakeholder computers connected to a platform, the consortium of stakeholders providing user inputted data associated with product supply chain information;
the platform being integrated with a blockchain database, the platform being configured to verify and assign values to the user inputted data and link the user inputted data to an associated data within the blockchain database, the platform being configured to group of related blockchains to provide a roadmap of the product supply chain information; and
a user interface configured to display qualified data based on user search queries and return results on data relevant to the product supply chain information.

12. The management system of claim 11, wherein the product supply chain information displayed in the user interface includes track and trace information relevant to a user searched variable.

13. The management system of claim 11, wherein the user inputted data further comprising carbon credits associated with a product; wherein the platform validates and assigns a value to the product based on the user inputted data and links the value to the group of related blockchains.

14. The management system of claim 13, wherein the user inputted data contains values for carbon credits associated with growing hemp, and wherein the platform calculates and divides values for the carbon offset credits based on attributes and stage of the products.

15. The management system of claim 14, wherein the platform issues digital tokens to stakeholders based on the values for carbon offset credits.

16. The management system of claim 11, wherein the platform validates credentials, licenses and certifications from user inputted data and attributes a value to the user inputted data based on criteria set by the system.

17. The management system of claim 11, wherein the platform tracks the product providence at a stage and assigns a product attribute to an associated blockchain.

18. The management system of claim 17, wherein the platform records a chain of custody in an associated blockchain for the product attribute.

19. The management system of claim 17, wherein the product attribute includes data associated with raw materials and processed materials and the stage of the materials at the time a value is assigned.

20. The management system of claim 19, wherein the product attribute includes values assigned to a product that is associated with a product information and quality.
